(19) United States
(12) Patent Application Publication
(10) Pub. No.: US 2025/0153471 A1
(43) Pub. Date: May 15, 2025

(54) MULTILAYER FILMS, POLYIMIDE FILMS AND COVERLAY PACKAGES

(71) Applicant: DUPONT ELECTRONICS, INC., WILMINGTON, DE (US)

(72) Inventors: SCOTT JOHN HERRMANN, CIRCLEVILLE, OH (US); LAILA MACLAUGHLIN, CIRCLEVILLE, OH (US); MICHAEL FRANZ MULZER, CIRCLEVILLE, OH (US)

(21) Appl. No.: 18/941,412

(22) Filed: Nov. 8, 2024

Related U.S. Application Data
(60) Provisional application No. 63/598,637, filed on Nov. 14, 2023.

(51) Int. Cl. B32B 27/08; B32B 7/027; B32B 7/06; B32B 27/28

(52) U.S. Cl. CPC B32B 27/08; B32B 7/027; B32B 7/06; B32B 27/281; B32B 27/283; B32B 2307/30; B32B 2307/4026; B32B 2307/406; B32B 2307/408; B32B 2307/538; B32B 2307/7376; B32B 2307/748; B32B 2457/00

(57) ABSTRACT

In a first aspect, a multilayer film includes a polymer substrate having a glass transition temperature of 240° C. or higher, a release layer adhered to the polymer substrate and a polyimide film layer releasably adhered to the release layer on a side opposite the polymer substrate. The release layer includes a cross-linked silicone having a decomposition temperature of 350° C. or higher. The polyimide film layer has a thickness of 10 μm or less. In a second aspect, a polyimide film having a thickness of 10 μm or less is derived from the multilayer film of the first aspect. In a third aspect. a coverlay package includes the multilayer film of the first aspect, an adhesive layer adhered to the polyimide film layer on a side opposite the release layer, and a release film releasably adhered to the adhesive layer on a side opposite the polyimide film layer.

### FIELD OF DISCLOSURE

The field of this disclosure is multilayer films, polyimide films and coverlay packages.

### BACKGROUND OF THE DISCLOSURE

Industry increasingly desires polyimide films for electronic applications to be matte in appearance, have a specific color, be durable to handling and circuit processing, and when used as a coverlay, provide security against unwanted visual inspection of the electronic components protected by the coverlay.

As electronic devices and their electronic components become increasingly thin and compact, the challenge to form a coverlay with low gloss and good mechanical properties that can be processed on standard equipment in roll format becomes even more difficult. In some cases, the need for thinner coverlays limits the use of matting agents, which may have particle sizes on the order of the thickness of the film. A need exists for a single layer thin polymer film that is matte in appearance, as well as providing sufficient optical density to provide visual security when used as a coverlay while having acceptable electrical properties (e.g., dielectric strength) mechanical properties, and durability to handling and circuit processing. This film should also be as resistive against post treatment etching processes as thicker films.

### DETAILED DESCRIPTION

In a first aspect, a multilayer film includes a polymer substrate having a glass transition temperature of 240° C. or higher, a release layer adhered to the polymer substrate and a polyimide film layer releasably adhered to the release layer on a side opposite the polymer substrate. The release layer includes a cross-linked silicone having a decomposition temperature of 350° C. or higher. The polyimide film layer has a thickness of 10 μm or less.

In a second aspect. a coverlay package includes the multilayer film of the first aspect, an adhesive layer adhered to the polyimide film layer on a side opposite the release layer, and a release film releasably adhered to the adhesive layer on a side opposite the polyimide film layer.

In one embodiment, a multilayer film includes a polymer substrate layer, a release layer, and a polyimide film layer, in which the release layer is in between the polymer substrate and the polyimide film layer. Both the polymer substrate and the release layer are configured in such a way that they can withstand the harsh temperature conditions that are needed to first deposit a polyamic acid mixture on the side of the substrate bearing the release layer and subsequently converting it into a polyimide film layer. After the conversion step, the release layer allows a clean and complete release of the polyimide film layer which may have a thickness of 10 μm or less to yield a free-standing polyimide film. The polyimide film layer may contain filler to impart color, and may be coated with additional layers, and may find use as part of a coverlay in a coverlay application.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polyimide film layers. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

It will be understood that although the terms first, second, third, etc. may be used herein to describe various elements, components, regions, layers and/or sections, these elements, components, regions, layers, and/or sections should not be limited by these terms. These terms are only used to distinguish one element, component, region, layer and/or section from another element, component, region, layer and/or section. Thus, a first element, component, region, layer and/or section could be termed a second element, component, region, layer and/or section without departing from the teachings of the present invention. Similarly, the terms “top” and “bottom” are only relative to each other. It will be appreciated that when an element, component, layer or the like is inverted, what is the “bottom” before being inverted would be the “top” after being inverted, and vice versa. When an element is referred to as being “on” or “disposed on” another element, it means positioning on or below the object portion, but does not essentially mean positioning on the upper side of the object portion based on a gravity direction, and it can be directly on the other element or intervening elements may be present therebetween. In contrast, when an element is referred to as being “directly on” or “disposed directly on” another element, there are no intervening elements present.

Further, it will also be understood that when one element, component, region, layer and/or section is referred to as being “between” two elements, components, regions, layers and/or sections, it can be the only element, component, region, layer and/or section between the two elements, components, regions, layers and/or sections, or one or more intervening elements, components, regions, layers and/or sections may also be present.

### Organic Solvents

Useful organic solvents for the synthesis of the polyimide film layers of the present invention are preferably capable of dissolving the polyimide precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), N,N-dimethylacetamide (DMAc), methyl ethyl ketone (MEK), N,N-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and N,N-dimethylacetamide (DMAc).

### Diamines

In one embodiment, any number of suitable diamines can be used for monomers to form the backbone of the polyimide film layer, or its polyamic acid precursor polymers. Aromatic diamines can include fluorinated aromatic diamines, such as 2,2′-bis(trifluoromethyl)benzidine (TFMB), 2,2′-bis-(4-aminophenyl) hexafluoropropane, 4,4′-diamino-2,2′-trifluoromethyldiphenyloxide, 3,3′-diamino-5,5′-trifluoromethyldiphenyloxide, 9,9′-bis(4-aminophenyl) fluorene, 4,4′-trifluoromethyl-2,2′-diaminobiphenyl, 4,4′-oxy-bis[2-trifluoromethyl)benzeneamine] (1,2,4-OBABTF), 4,4′-oxy-bis[3-trifluoromethyl)benzeneamine], 4,4′-thiobis[(2-trifluoromethyl)benzeneamine], 4,4′-thiobis[(3-trifluoromethyl)benzeneamine], 4,4′-sulfoxyl-bis[(2-trifluoromethyl)benzeneamine, 4,4′-sulfoxyl-bis[(3-trifluoromethyl)benzeneamine], 4,4′-keto-bis[(2-trifluoromethyl)benzeneamine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenylether; 1,4-(2′-trifluoromethyl-4′,4″-diaminodiphenoxy)benzene, 1,4-bis(4′-aminophenoxy)-2-[(3′,5′-ditrifluoromethyl)phenyl]benzene (6F-amine), 1,4-bis[2′-cyano-3′ (“4-amino phenoxy) phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-bis[4 (4-aminophenoxy)phenyl]phthalein-3′,5′-bis(trifluoromethyl) anilide (6FADAP) and 3,3′,5,5′-tetrafluoro-4,4′-diamino-diphenylmethane (TFDAM).

Other useful aromatic diamines can include 4,4′-diaminobiphenyl, 4,4″-diaminoterphenyl, 4,4′-diaminobenzanilide (DABA), 4,4′-diaminophenylbenzoate, 4,4′-diaminobenzophenone, 4,4′-diaminodiphenylmethane (MDA), 4,4′-diaminodiphenylsulfide, 4,4′-diaminodiphenylsulfone, 3,3′-diaminodiphenylsulfone, bis[4-(4-aminophenoxy)phenyl]sulfone (BAPS), 4,4′-bis(4-aminophenoxy) biphenyl (BAPB), 4,4′-diaminodiphenylether (ODA), 3,4′-diaminodiphenylether, 4,4′-isopropylidenedianiline, 2,2′-bis(3-aminophenyl) propane, 2,2-bis(4-aminophenyl) propane, 3,3′-dimethyl-4,4′-diaminobiphenyl, 4-aminophenyl-3-aminobenzoate, bis(p-beta-amino-t-butylphenyl) ether, p-bis-2-(2-methyl-4-aminopentyl)benzene. In one embodiment, the diamine is a triamine, such as N,N-bis(4-aminophenyl)-n-butylamine, N,N-bis(4-aminophenyl)methylamine or N,N-bis(4-aminophenyl) aniline.

Other useful aromatic diamines can include 1,2-bis(4-aminophenoxy)benzene, 1,3-bis(4-aminophenoxy)benzene (RODA), 1,2-bis(3-aminophenoxy)benzene, 1,3-bis(3-aminophenoxy)benzene, 1-(4-aminophenoxy)-3-(3-aminophenoxy)benzene, 1,4-bis-(4-aminophenoxy)benzene, 1,4-bis(3-aminophenoxy)benzene, 1-(4-aminophenoxy)-4-(3-aminophenoxy)benzene, 2,2-bis(4-[4-aminophenoxy]phenyl) propane (BAPP), 2,2′-bis(4-phenoxyaniline) isopropylidene.

Other useful aromatic diamines can include p-phenylenediamine (PPD), m-phenylenediamine (MPD), 2,5-dimethyl-1,4-diaminobenzene, 2,5-dimethyl-1,4-phenylenediamine (DPX), 1,4-naphthalenediamine, 1,5-naphthalenediamine, 1,5-diaminonaphthalene, m-xylylenediamine, and p-xylylenediamine.

In one embodiment, additional useful diamines for forming the polyimide can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

Other useful additional diamines for forming the polyimide can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro[3.3]heptane), bicyclo[2.2.1]heptane-1,4-diamine, isophoronediamine, and bicyclo[2.2.2]octane-1,4-diamine. Other alicyclic diamines can include cis-1,4-cyclohexanediamine, trans-1,4-cyclohexanediamine, 1,4-bis(aminomethyl)cyclohexane, 4,4′-methylenebis(cyclohexylamine), 4,4′-methylenebis(2-methyl-cyclohexylamine), bis(aminomethyl) norbornane.

In one embodiment, preferred diamine monomers are ODA, PPD, and mixtures thereof.

### Dianhydrides

In one embodiment, any number of suitable dianhydrides can be used for monomers to form the backbone of the polyimide film layer, or its polyamic acid precursor polymers. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable aromatic dianhydrides include 3,3′,4,4′-biphenyltetracarboxylic dianhydride (BPDA), 2-(3′,4′-dicarboxyphenyl)-5,6-dicarboxybenzimidazole dianhydride, 2-(3′,4′-dicarboxyphenyl)-5,6-dicarboxybenzoxazole dianhydride, 2-(3′,4′-dicarboxyphenyl)-5,6-dicarboxybenzothiazole dianhydride, 2,2′,3,3′-benzophenonetetracarboxylic dianhydride, 2,3,3′,4′-benzophenonetetracarboxylic dianhydride, 3,3′,4,4′-benzophenonetetracarboxylic dianhydride (BTDA), 2,2′,3,3′-biphenyltetracarboxylic dianhydride, 2,3,3′,4′-biphenyltetracarboxylic dianhydride, 4,4′-thio-diphthalic anhydride, bis(3,4-dicarboxyphenyl) sulfone dianhydride, bis(3,4-dicarboxyphenyl) sulfoxide dianhydride (DSDA), bis(3,4-dicarboxyphenyloxadiazole-1,3,4)-p-phenylene dianhydride, bis(3,4-dicarboxyphenyl)-2,5-oxadiazole-1,3,4-dianhydride, bis(3′,4′-dicarboxydiphenylether)-2,5-oxadiazole-1,3,4-dianhydride, 4,4′-oxydiphthalic anhydride (ODPA), bis(3,4-dicarboxyphenyl)thioether dianhydride, bisphenol A dianhydride (BPADA), bisphenol S dianhydride, bis-1,3-isobenzofurandione, 1,4-bis(4,4′-oxyphthalic anhydride)benzene, bis(3,4-dicarboxyphenyl) methane dianhydride, perylene-3,4,9,10-tetracarboxylic dianhydride, 1,3-bis-(4,4′-oxydiphthalic anhydride)benzene, 2,2-bis(3,4-dicarboxyphenyl) propane dianhydride, 4,4′-(hexafluoroisopropylidene)diphthalic anhydride (6FDA) and 9,9-bis(trifluoromethyl)-2,3,6,7-xanthenetetracarboxylic dianhydride.

In one embodiment, additional dianhydrides for forming the polyimide can include 1,2,5,6-naphthalenetetracarboxylic dianhydride, 1,4,5,8-naphthalenetetracarboxylic dianhydride, 2,3,6,7-naphthalenetetracarboxylic dianhydride, bicyclo-[2,2,2]-octen-(7)-2,3,5,6-tetracarboxylic-2,3,5,6-dianhydride, cyclopentadienyltetracarboxylic dianhydride, ethylenetetracarboxylic dianhydride, pyromellitic dianhydride (PMDA), tetrahydrofurantetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, additional dianhydrides for forming the polyimide can include an alicyclic dianhydride, such as cyclobutane-1,2,3,4-tetracarboxylic diandydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c: 4,5-c′]difuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride.

In one embodiment, preferred dianhydride monomers are PMDA, BPDA, and mixtures thereof.

### Polyamic Acid Solutions

In one embodiment, a polyimide film layer can be produced by combining a diamine and a dianhydride (monomer or other polyimide precursor form) together with a solvent to form a polyamic acid (also called a polyamide acid) solution and converting the solution into a polyimide film layer. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid and the corresponding polyimide film layer is formally derived from 50 mole % pyromellitic dianhydride (PMDA) and 50 mole % 4,4′-diaminodiphenylether (ODA). In other embodiments, a polyamic acid and the corresponding polyimide film layer is formally derived from ODA (32 wt %), PPD (12 wt %), and PMDA (56 wt %) (composition “A”), or ODA (3 wt %), PPD (26 wt %), BPDA (65 wt %) and PMDA (7 wt %) (composition “B”), or ODA (21 wt %), PPD (17 wt %), BPDA (30 wt %) and PMDA (32 wt %) (composition “C”).

In one embodiment a polyamic acid or a polyimide film layer can have a weight-average molecular weight (Mw) of 100,000 daltons or more, 150,000 daltons or more, 200,000 daltons or more, or 250,000 daltons or more.

In one embodiment, a polyamic acid casting solution is derived from the polyamic acid solution. In this context, the word solution refers to a liquid mixture of varying viscosity that may be composed of more than one phase, and may also be described as a dispersion, suspension, or colloid. If more than one phase is present, then the additional phase or phases are homogeneously dispersed throughout the continuous phase, and no sediment or precipitate is present.

In one embodiment, the polyamic acid solution is dissolved in an organic solvent at a concentration from about 5.0 or 10 percent to 15, 20, 25, 30, 35 or 40 percent by weight.

In one embodiment, the polyamic acid solution comprises additional components (e.g., a colorant such as a filler, pigment, dye) to impart color to the solution and the resulting solidified layer or film. In one embodiment, a colorant comprises carbon black.

In one embodiment, a slurry comprising the polyamic acid solution and a filler is prepared, where the slurry has a solids content in a range of from 0.1 to 70, from 0.5 to 60, from 1 to 55, from 5 to 50, or from 10 to 45 percent by weight. The slurries may or may not be milled using a ball mill to reach the desired particle size. The slurries may or may not be filtered to remove any residual large particles or agglomerates. A polyamic acid solution can be made by methods well known in the art. The polyamic acid solution may or may not be filtered. In some embodiments, the solution is mixed in a high shear mixer with the filler slurry. When a polyamic acid solution is made with a slight excess of diamine, additional dianhydride solution may or may not be added to increase the viscosity of the mixture to the desired level for film casting. The amount of the polyamic acid solution, and filler slurry can be adjusted to achieve the desired loading levels in the cured film.

In one embodiment, a pigment is added to the polyamic acid solution. Virtually any pigment (or combination of pigments) can be used in the performance of the present invention. In some embodiments, useful pigments include but are not limited to the following: Barium Lemon Yellow, Cadmium Yellow Lemon, Cadmium Yellow Lemon, Cadmium Yellow Light, Cadmium Yellow Middle, Cadmium Yellow Orange, Scarlet Lake, Cadmium Red, Cadmium Vermilion, Alizarin Crimson, Permanent Magenta, Van Dyke brown, Raw Umber Greenish, or Burnt Umber. In some embodiments, useful black pigments include: cobalt oxide, Fe—Mn—Bi black, Fe—Mn oxide spinel black, (Fe,Mn) 203 black, copper chromite black spinel, lampblack, bone black, bone ash, bone char, hematite, black iron oxide, micaceous iron oxide, black complex inorganic color pigments (CICP), CuCr₂O₄ black, (Ni,Mn,Co)(Cr,Fe)₂O₄ black, Aniline black, Perylene black, Anthraquinone black, Chromium Green-Black Hematite, Chrome Iron Oxide, Pigment Green 17, Pigment Black 26, Pigment Black 27, Pigment Black 28, Pigment Brown 29, Pigment Black 30, Pigment Black 32, Pigment Black 33 or mixtures thereof.

In one embodiment, a low conductivity carbon black is added to the polyamic acid solution as a filler. The amount of low conductivity carbon black and the thickness of the polyimide film will generally impact the optical density. If the low conductivity carbon black loading level is unduly high, the polyimide film will be conductive even when a low conductivity carbon black is used. If too low, the polyimide film may not achieve the desired optical density and color. The low conductivity carbon black, for the purpose of this disclosure, is used to impart the black color to the polyimide film as well as to achieve the desired optical density. Low conductivity carbon black is intended to mean, channel type black or furnace black. In some embodiments a bone black may be used to impart the black color. In one embodiment, the low conductivity carbon black is present in amount of from 5 to 18 weight percent of the polyimide film layer. In some embodiments, the optical density (opacity) desirable (e.g., to hide the conductor traces in the flex circuits from view) lies in a range of 2 to 3. An optical density of 2 is intended to mean 1×10⁻² or 1% of light is transmitted through the polyimide film. In one embodiment, a polyimide film layer has an optical density of 1.5 or more, when measured on a film having a thickness of 5 μm. In one embodiment, a polyimide film layer has an L* of 40 or less, 35 or less, 30 or less, or 25 or less.

In one embodiment, the low conductivity carbon black is a surface oxidized carbon black. One method for assessing the extent of surface oxidation (of the carbon black) is to measure the carbon black's volatile content. The volatile content can be measured by calculating weight loss when calcined at 950° C. for 7 minutes. Generally speaking, a highly surface oxidized carbon black (high volatile content) can be readily dispersed into a polyamic acid solution (polyimide precursor), which in turn can be imidized into a (well dispersed) filled polyimide base polymer of the present disclosure. It is thought that if the carbon black particles (aggregates) are not in contact with each other, then electron tunneling, electron hopping or other electron flow mechanism are generally suppressed, resulting in lower electrical conductivity. In some embodiments, the low conductivity carbon black has a volatile content greater than or equal to 1%. In some embodiments, the low conductivity carbon black has a volatile content greater than or equal to 5, 9, or 13%. In some embodiments, furnace black may be surface treated to increase the volatile content.

A uniform dispersion of isolated, individual particles (aggregates) not only decreases the electrical conductivity, but additionally tends to produce uniform color intensity. In some embodiments the low conductivity carbon black is milled. In some embodiments, the mean particle size of the low conductivity carbon black is between (and optionally including) any two of the following sizes: 0.2, 0.3, 0.4, 0.5, 0.6, 0.7, 0.8, 0.9 and 1.0 microns.

In one embodiment, dyes may be used as part of the polyamic acid solution. Examples of useful dyes are, but not limited to nigrosin black, monoazo chromium complex black, and mixtures thereof.

In one embodiment, an inorganic black filler may be used as part of the polyamic acid solution. The filler may be an oxide, nitride, sulfide, phosphate, halide, carbide or the like of a metal, e.g., black titanium (IV)dioxide.

In one embodiment, a mixture of dye and/or pigment and/or carbon black and/or inorganic black filler may be used. In other embodiments, the polyamic acid solution is essentially free of silicon-containing particles and/or the polyamic acid is free of silicon-containing monomers and of fluoride-containing monomers. In some embodiments the dye and/or pigment and/or carbon black and/or inorganic black filler present in the polyamic acid solution remains as the solution is converted into a polyimide film layer.

In one embodiment, the polyamic acid solution can further comprise any one of a number of additives, such as processing aids (e.g., oligomers, antioxidants, light stabilizers, flame retardant additives, anti-static agents, components resisting plasma or corona, heat stabilizers, ultraviolet absorbing agents or various reinforcing agents.

In one embodiment, the polyamic acid solution further comprises a matting agent. Silicas are inorganic particles that can be ground and filtered to specific particle size ranges. The very irregular shape and porosity of silica particles and low cost make it a popular matting agent. Other potential matting agents can include: i. other ceramics, such as, borides, nitrides, carbides and other oxides (e.g., alumina, titania, etc); and ii. organic particles, provided the organic particle can withstand processing temperatures of from about 250° C. to about 550° C., depending upon the particular polyimide process chosen. One matting agent that can be useful in polyimide applications (i.e. one that can withstand the thermal conditions of polyimide synthesis) are polyimide particles.

The amount of matting agent, median particle size and density must be sufficient to produce the desired 60° gloss value. In some embodiments, the polyimide film 60° gloss value is between and optionally including any two of the following: 2, 5, 10, 15, 20, 25, 30 and 35. In some embodiments, the polyimide film 60° gloss value is from 10 to 35.

In one embodiment, the matting agent is present in an amount between and optionally including any two of the following: 1.6, 2, 3, 4, 5, 6, 7, 8, 9 and 10 weight percent of polyimide film. In some embodiments, the matting agent has a median particle size between and optionally including any two of the following: 1.3, 2, 3, 4, 5 microns. The matting agent particles should have an average particle size of less than (or equal to) about 5 microns and greater than (or equal to) about 1.3 microns. Larger matting agent particles may negatively impact mechanical properties of the final polyimide film. In some embodiments, the matting agent has a density between and optionally including any two of the following: 2, 3, 4 and 4.5 g/cc. In some embodiments, when the amount of matting agent is below 1.6 weight percent of polyimide film, the desired 60° gloss value is not achieved even when the matting agent median particle size and density are in the desired ranges. In some embodiments, when the median particle size is below 1.3 microns, the desired 60° gloss value is not achieved even when the amount of matting agent and density are in the desired ranges. In some embodiments, the matting agent is selected from the group consisting of silica, alumina, barium sulfate and mixtures thereof.

### Polymer Substrates

Polymer substrates suitable for this invention are polymer films and thermoplastic polymer films having a thickness in a range of from 7 to 100 μm that can tolerate the conversion temperatures needed to form the polyimide film layer on the substrate without developing visual defects in random areas of the polyimide film layer that are a result of the substrate shrinking, wrinkling, distorting, blistering, melting, flowing, or undergoing other adverse processes that compromise the mechanical integrity of the substrate and the polyimide film layer. In one embodiment, the polymer substrate has thermal properties such as a glass transition temperature or coefficient of thermal expansion (average of the transverse and machine direction) that are close to that of the polyimide film layer that is subsequently formed. In one embodiment, the polymer substrate has a glass transition temperature (Tg) of 240° C. or higher, 260° C. or higher, 280° C. or higher, 300° C. or higher, 325° C. or higher, or 350° C. or higher. In one embodiment, the polymer substrate has mechanical properties such as a tensile modulus or ultimate tensile strength that are close to the polyimide film layer that is being formed. In one embodiment, the polymer substrate may be chosen from polyimide films (e.g., Kapton® films from DuPont de Nemours, Inc., Willmington, DE), aromatic polyaramid material (Nomex® films from DuPont), polyamide-imide films, polybenzimidazole films, polyaryletherketone films, polyarylether films, polyphenylenesulfide films, or films based on arylsulfones.

In one embodiment, one or both surfaces of the polymer substrate have a 60° gloss value of 50 or less, or 40 or less, or 30 or less, or 25 or less.

In one embodiment, one or both surfaces of the polymer substrate have a water-contact angle of 100° or less, or 90° or less, or 85° or less prior to applying a release coating.

In one embodiment, the polymer substrate is substantially free of silicone and/or fluorine particles or monomers. In one embodiment, the polymer substrate may contain fiber fillers as commonly used in the production of aromatic polyaramid material.

### Release Layers

The term “polymer” includes homopolymers, copolymers, block copolymers and terpolymers.

The term “C₁-Cₙ alkyl” refers to a monovalent group that contains 1 to n carbons atoms, that is a radical of an alkane and includes straight-chain and branched organic groups. For example, a “C₁-C₃₀ alkyl” refers to a monovalent group that contains from 1 to 30 carbons atoms, that is a radical of an alkane and includes straight-chain, cyclic (if geometrically possible), and branched organic groups. Examples of alkyl groups include methyl; ethyl; propyl; isopropyl; n-butyl; isobutyl; sec-butyl; tert-butyl; n-pentyl; n-hexyl; n-heptyl; cyclopropyl; cyclobutyl; cyclopentyl; cyclohexyl; cycloheptyl; cyclooctyl; adamantane; norbornane and, 2-ethylhexyl. In addition, alkyl groups may be unsubstituted or may be substituted with one or more substituents such as halo, nitro, cyano, amido, amino, sulfonyl, sulfinyl, sulfanyl, sulfoxy, urea, thiourea, sulfamoyl, sulfamide and hydroxy.

The term “hetero” herein refers to groups or moieties containing one or more heteroatoms, such as N, O, Si and S. Thus, for example “heterocyclic” refers to cyclic groups having, for example, N, O, Si or S as part of the ring structure. “Heteroalkyl” and “heterocycloalkyl” moieties are alkyl and cycloalkyl groups as defined hereinabove, respectively, containing N, O, Si or S as part of their structure.

In one embodiment, a release layer comprises a silicone-based release layer. To form a silicone release layer, a coating solution comprising the following components is used:
(a) at least one siloxane oligomer or polymer,
(b) at least one silicon-based entity capable of acting as a crosslinker,
(c) optionally an adhesion promoter,
(d) optionally a curing catalyst, and
(e) a liquid carrier.

The coating solution to create the silicone release layer comprises one or more siloxane oligomers or polymers. Each siloxane oligomer or polymer may have a branched or linear structure, or elements of both. In some embodiment, the siloxane is a polydiorganosiloxane, particularly one of the form SiR¹R²X¹O—(SiR³R⁴O)ₙ—SiR⁵R⁶X². The number of repeat units “n” determines the molecular weight and viscosity of the siloxane oligomer or polymer. Substituents R¹, R², R³, R⁴, R⁵, and R⁶ may be the same or different and may be siloxane, alkyl, allyl, aryl, alkoxy, amino, hydroxyl, hydrogen, mercapto, halo, and cyano, and n is from 0 to about 100,000. In some embodiments, the polydiorganosiloxane contains at least one alkyl group and/or at least one aryl group. The alkyl group may be selected from a C₁-C₂₀ alkyl group, preferably a C₁-C₈ alkyl group, preferably a methyl group. The aryl group may be selected from a C₆-C₁₈ aryl group, preferably a phenyl group. In some embodiments, the polydiorganosiloxane has the structure of a polydimethylsiloxane. Substituents X¹ and X² may be the same or different and may be selected from amino, acetoxy, alkoxy, alkyl, allyl, hydroxyl, hydrogen, vinyl, enoxy, and oxime functional groups. The alkoxy group may be selected from a C₁-C₈ alkoxy group, especially a methoxy or ethoxy group. In some embodiments at least one or more hydroxyl or alkoxy group is attached directly to a silicon atom. Desirable siloxanes include any hydroxy or alkoxy terminated siloxanes that can form a film coating when combined with an appropriate crosslinker. In preferred embodiments, the polydiorganosiloxane is a dihydroxy or dialkoxy polydiorganosiloxane or mixtures thereof. Mixtures comprising polydiorganosiloxanes having different molecular weights may be used. The polydiorganosiloxane may be present in the coating solution by itself, and/or in forms in which it has already partially or fully reacted with a silicon-based entity capable of acting as a crosslinker. The amount of polydiorganosiloxane present in the release layer in its fully cured state may be from 75 to 99% by weight.

The coating solution can be applied onto a substrate such as a film in form of a solution or as a dispersion in a liquid medium or carrier. The liquid medium or carrier may be aqueous and/or organic solvent based, such as, for example, ketones, esters, ethers, aromatic hydrocarbons, aliphatic hydrocarbons, lactones, amides, alcohols, mixtures thereof, or water. The coating solution may be applied as a single coating. However, additional coats can be applied as well. If multiple coatings are applied, a curing step may be performed between each application step.

Application of the coating solution in exemplary embodiments disclosed herein can be accomplished in any number of ways. Such methods include using a slot die, gravure, or reverse gravure. Additional coating methods include dip coating, or kiss-roll coating a substrate followed optionally by metering with doctor knife, doctor rolls, squeeze rolls, or an air knife. The coating may also be applied by brushing or spraying. By using such techniques, it is possible to prepare both one and two-sided coated substrates. In preparation of the two-side coated structures, one can apply the coatings to the two sides of a polymer either simultaneously or consecutively before going to the curing and drying stage of the coating solution.

The coating solution may have a non-volatile solid content in the liquid medium in an amount of 0.05 to 10 wt %, or more preferably 0.5 to 5 wt %.

The non-volatile solid content, once applied to a substrate and dried, may be cured. In this context, “cure” refers to a process that changes the state and/or structure of the non-volatile solid content that can is usually, but not necessarily, triggered by a variable such as moisture, temperature, and/or addition of chemical such as a base, acid, or other catalyst. The curing process may be partial or complete in terms of converting reactive groups contained in the coating solution such as silanol groups. Conversion of the reactive groups may occur by several reaction mechanisms, of which a condensation reaction driven by humidity/moisture at ambient temperature is preferred. In one embodiment, the dried coating solution is allowed to cure at ambient moisture and ambient temperature over the course of 24 hours or less. In another embodiment, heat is applied to speed up the curing process. Curing times may be additionally shortened by addition of more moisture or one or more appropriate catalyst, such as an acid, base, or metal-based compound, or mixtures thereof. Several methods may be combined to accelerate the curing process.

The cured release layer may have an average dry coating thickness of less than 1 μm when applied to the surface of a substrate. In one embodiment, the average dry coating thickness is less than 0.5 μm as calculated based on the change in unit weight of the substrate after applying, drying, and curing the release layer. In one embodiment, the release layer has a thickness in a range of from 5 to 500 nm.

Appropriate curing catalysts include tin compounds, of which organotin compounds or inorganic tin salts can be used such as tin (II) chloride, tin (IV) chloride, di(n-butyl) tin (IV) di(acetylacetonate), di(n-octyl) tin (IV) di(acetylacetonate), (n-octyl) (n-butyl) tin (IV) di(acetylacetonate); di-n-butyltin dilaurate, di-n-butyltin maleate, di-n-butyltin diacetate, di-n-octyltin dilaurate, dioctyltin dineodecanoate, dimethyltin dineodecanoate, di-n-octyltin diacetate, di-n-butyltin dimethoxide; di-n-butyltin oxide and di-n-octyltin oxide; tin (II) octoate, tin (II) phenolate, di(n-butyl) tin (IV) di(methyl maleate), di(n-butyl) tin (IV) di(butyl maleate), di(n-octyl) tin (IV) di(methyl maleate), di(n-octyl) tin (IV) di(butyl maleate), di(n-octyl) tin (IV) di(isooctyl maleate); and di(n-butyl) tin (IV) sulfide. Organotin compounds are preferred.

Other metal-based catalyst may be used such as based on titanium (e.g. organotitanates or chelate complexes), cerium, zirconium, molybdenum, manganese, copper, aluminum, bismuth, iron, strontium, boron, or zinc, in the form of their inorganic salts with organo-based ligands. Examples include boron trifluoride, boron trichloride, boron tribromide, boron triiodide, or mixtures of boron halides, boron trifluoride diethyl etherate. Other examples include aluminum alkoxides Al(OR^{x})₃ and titanium alkoxides Ti(OR^{x})₄ where R^{x} is hydrogen or an organic substituent, preferably a C₁-C₂₀ hydrocarbon group, and the 4 alkoxy groups OR^{x} are identical or different. One or more of the OR^{x} groups may be replaced by acyloxy groups O₂CR^{x}. Further examples include tetramethoxyzirconium, tetraethoxyzirconium, diisopropoxyzirconium bis(ethyl acetoacetate), triisopropoxyzirconium (ethyl acetoacetate), isopropoxyzirconium tris(ethyl acetoacetate), zirconium acylates, halogenated zirconium compounds, carboxylates of calcium, vanadium, iron, zinc, titanium, potassium, barium, manganese, and zirconium. The amount of catalyst (or total mixture of catalysts) relative to the amount to be cured ranges from 0.05 to 2% by weight ratio.

Non-metal based catalysts may also be used such as amines. Suitable compound include nitrogen heterocycles and guanidine derivatives such as 1,8-diazabicyclo[5.4.0]undec-7-ene (DBU).

The coating solution to create the silicone release layer comprises also one or more silicon-based entity capable of acting as a crosslinker to produce crosslinks with the siloxane and/or with itself and/or the surface on which the coating solution is deposited.

A silicon-based entity capable of acting as a crosslinker and suitable for a condensation-type cure includes molecules containing just a single silicon atom such as R^{a}Si(XR^{b})₃ or Si(XR^{b})₄, or linear or cyclic or branched silicone oligomers that comprise at least two functional reactive groups XR^{b} attached directly to silicon atoms. Suitable functional groups XR^{b} include alkoxy alkyls, acetoxy, amino, mono-alkyl substituted amino, di-alkyl substituted amino, hydroxy, oximino, amido, and enoxy groups or combinations thereof. Substituent R^{a} may be siloxane, alkyl, allyl, aryl, vinyl, or hydrogen.

In one embodiment, the crosslinker is a silicone R^{a}Si(XR^{b})₃ comprising alkyl substituted amino-reactive groups as XR^{b}, particularly NR₂ or NHR in which R is an alkyl group C₁-C₆, preferably C₁-C₂. R^{a} in this case is also preferably an alkyl group C₁-C₆, preferably methyl or ethyl. In some embodiments the silicone comprises a cyclic structure or is part of a ladder structure. Cyclic silicones may contain one or more closed rings. Ladder structures contain linear chains that crosslink in a ladder-like formation.

In some embodiments the silicon-based entity capable of acting as a crosslinker may be present in the coating solution in unreacted form, and/or in a form that has partially or even fully reacted with water, itself, and/or the siloxane oligomers or polymers present in the coating solution to form a bond of the type Si—OH and/or Si—O—Si. In some embodiments the silicon-based entity capable of acting as a crosslinker is no longer present in unreacted form in the coating solution because at least one of its functional groups has reacted with water, itself, and/or the siloxane oligomers or polymers to form a bond of the type Si—OH and/or Si—O—Si.

In one embodiment, the coating solution to create the silicone release layer comprises a silanol terminated poly(dialkyl-substituted orthosilicic acid) polymer or oligomer, and at least one tris-heteroalkyl-substituted alkylsilane compound, particularly tris-(N-methylamine) methylsilane. Reaction products of the silanol terminated poly(dialkyl-substituted orthosilicic acid) polymer or oligomer with the tris-heteroalkyl-substituted alkylsilane compound may also be included, and may even represent the major or sole component in the coating solution.

The amount of the silicon-based entity capable of acting as a crosslinker present in the fully cured state may be from 1 to 25% by weight when viewed present as in its formally unreacted state.

In one embodiment, applying and curing the release coating onto a substrate does not significantly change the measured 60° gloss of the substrate itself, nor does it change the transfer of the gloss value from the substrate in cases where a coating is applied separately onto the side of the substrate bearing the release coating, the coating then being cured and subsequently released from the substrate bearing the release coating, and the gloss value of said coating then being compared to the gloss value of the substrate before applying the coating.

In one embodiment, the cured release coating changes the water-contact angle of the substrate it is coated on. In one embodiment the water-contact angle of the substrate bearing the cured release coating is in the range of from 95 to 115°, from 100 to 115°, or from 105 to 115°.

The cured silicone release coating may have a high thermal stability. Silicone materials typically have a thermal decomposition temperature less than 200° C. in the case of silicone oils or an operating range of −60° C. to +230° C. and tolerate temperature exposure of up to 300° C. in the case of silicone rubbers. Additionally, common silicone resins have an initial onset thermal decomposition temperature of about 200 to 400° C. which makes them unable to be applied in high-temperature conditions, and the onset temperature of degradation typically lies in the range of 300 to 350° C. under air or nitrogen, whereby degradation is initiated above 340° C. and causes an oxidative depolymerization of, for example, PDMS or PMPS polymer backbones, resulting in the formation of linear and cyclic oligomers.

In one embodiment, the cured release coating has a high thermal stability up to at least 400° C., as evidenced by the lack of detected volatile silicone-containing species when exposing a substrate containing the cured release coating to 400° C. for the duration of one minute, capturing evolved volatile species in a cold trap, volatilizing trapped species again to then be separated, detected, and identified by GC/MS. In one embodiment, the release layer comprises a cross-linked silicone having a decomposition temperature (i.e., a temperature at which no volatile silicone-containing species are detected within the time span of one minute) of 350° C. or higher, 360° C. or higher, 370° C. or higher, 380° C. or higher, or 390° C. or higher.

The release layer coating solution may optionally contain at least one additional component to promote adhesion of the cured polymer to the substrate. Suitable adhesion promoters are silicon-based, especially alkoxysilanes R^{x}ₙSi(OR^{y}₄₋ₙ) in which substituent R^{x} contains a functional group such as an amino group, mercapto group, epoxy group, carboxyl group, vinyl group, isocyanate group, isocyanurate group. Mixtures of silanes may be used. In some embodiments, at least one compound from the group of amine-containing alkoxysilanes is selected. Examples include 3-aminopropyltrimethoxysilane, aminomethyltrimethoxysilane, aminomethyltriethoxysilane, (N-2-aminoethyl)-3-aminopropyltrimethoxysilane, (N-2-aminoethyl)-3-aminopropyltriethoxysilane, diethylenetriaminopropyltrimethoxysilane, phenylaminomethyltrimethoxysilane, (N-2-aminoethyl)-3-aminopropylmethyldimethoxysilane, β-(N-phenylamino)propyltrimethoxysilane, β-piperazinylpropylmethyldimethoxysilane, β-(N,N-dimethylaminopropyl) aminopropylmethyldimethoxysilane, tri[(3-triethoxysilyl)propyl]amine, tri[(3-trimethoxysilyl)propyl]amine, and the oligomers thereof, 3-(N,N-dimethylamino)propyltrimethoxysilane, β-(N,N-dimethylamino)-propyltriethoxysilane, (N,N-dimethylamino) methyltrimethoxysilane, (N,N-dimethylamino)methyltriethoxysilane, β-(N,N-diethylamino)propyltrimethoxysilane, β-(N,N-diethylamino)propyltriethoxysilane, (N,N-diethylamino)methyltrimethoxysilane, (N,N-diethylamino)methyltriethoxysilane, bis(3-trimethoxysilyl)propylamine, bis(3-triethoxysilyl)propylamin, 4-amino-3,3-dimethylbutyltrimethoxy silane and 4-amino-3,3-dimetylbuthyltriethoxy silane and mixtures thereof. The amount of adhesion promoter relative to the amount of non-volatile solids in the coating solution ranges from 0.1 to 5% by weight.

### Polyimide Film Layer

A polyimide film layer is formed by first depositing a polyamic acid solution onto the side of the polymer substrate having the release layer, removing the solvent, and subsequently converting the polyamic acid into a polyimide film layer. Application of the poylamic acid coating solution can be accomplished in any number of ways. Such methods include using a slot die, gravure, reverse gravure, dip coating, or kiss-roll coating followed optionally by metering with doctor knife, doctor rolls, squeeze rolls, or an air knife. The coating may also be applied by brushing or spraying. By using such techniques, it is possible to prepare a coated substrate.

The solvent is preferably removed by applying heat in convective or radiant form while processing the coating in a roll-to-roll format. In one embodiment, the coating applied to the substrate retains 5-40 wt % of solvent after the heating step. The resulting construction may then be placed on a tenter/pin frame, and cured in an oven, using convective and radiant heat to remove remaining solvent and complete the imidization in the polyamic acid layer to arrive at a polyimide film layer with greater than 98% solids level. The amount of imidization in the polyimide film layer may be 75% or more, 80% or more, 85% or more, 90% or more, or 95% or more. In another embodiment, the coating is processed in roll-to-roll format after the heating step to complete the imidization.

The thickness of the polyimide film layer may be adjusted, depending on the intended purpose of the film or final application specifications. In one embodiment, the polyimide film layer has a total thickness in a range of from 0.1 to 10, or 0.1 to 8, or 0.5 to 6 μm. In one embodiment, the polyimide film layer has a thickness of 10 μm or less, or 8 μm or less, or 6 μm or less.

In one embodiment, the polyimide film layer is formed on the substrate bearing the release layer in such a way that the gloss value of the substrate is mostly transferred to the side of the polyimide film layer that is facing the substrate. In one embodiment, the 60° gloss value of the side of the polyimide film layer in contact with the release layer is less than 30 gloss units after removing the polyimide film from the substrate. In one embodiment, the polyimide film layer, on a side not in contact with the release layer, has a 60° gloss that is greater than the gloss of the side in contact with the release layer by at least 20 gloss units.

In one embodiment, the polyimide film layer can be released from the substrate and the release layer without creating any visual defects in the resulting free-standing polyimide film such as wrinkles, curl, or tears.

In one embodiment, the polyimide film layer can be released from the substrate and the release layer without significant levels of Si contamination. In one embodiment, the polyimide film can have a Si content of less than 1 atom % on both surfaces.

In one embodiment, the polyimide film, after release from the substrate and the release layer, shows a coefficient of thermal expansion that is almost isotropic, i.e., the difference in coefficient of thermal expansion in machine and transverse direction is 5 ppm/° C. or less, 4 ppm/° C. or less, 3 ppm/° C. or less, or 2 ppm/° C. or less.

The polyimide film, after release from the substrate and the release layer, may have certain desirable mechanical or thermal properties such as: (a) an elongation to break in both machine and transverse film direction of 5%, 10%, 20%, 40%, or greater, (b) a tensile strength of 15 kpsi, 20 kpsi, or greater, (c) a tensile modulus of 300 kpsi, 500 kspi, 800 kpsi or greater, (d) a coefficient of thermal expansion in both machine and transverse film direction of less than 40 ppm/° C., (e) a thermal glass transition temperature of 200° C., 250° C., 300° C., 350° C. or greater, and/or (g) a thermal rating of 200° C. or greater. The testing of these properties may occur according to standard procedures known to the industry such as published by ASTM or UL.

In one embodiment, an imidization catalyst (sometimes called an “imidization accelerator”) can be used as a conversion chemical that can help lower the imidization temperature for forming the polyimide and shorten the imidization time. The polyamic acid casting solutions of the present invention may comprise both a polyamic acid solution combined with some amount of conversion chemicals. The conversion chemicals found to be useful include, but are not limited to: (i) one or more dehydrating agents and/or co-catalysts, such as, aliphatic acid anhydrides (acetic anhydride, trifluoroacetic anhydride, propionic anhydride, monochloroacetic anhydride, bromo adipic anhydride, etc.) and aromatic acid anhydrides; and (ii) one or more imidization catalysts, such as, aliphatic tertiary amines (triethylamine, etc.), aromatic tertiary amines (dimethylaniline, N,N-dimethyl benzylamine, etc.) and heterocyclic tertiary amines (pyridine, alpha-, beta-, gamma-picoline, 3,5-lutidine, 3,4-lutidene, isoquinoilne, etc.) and guanidines (e.g. tetramethylguanidine). In one embodiment, an imidization catalyst does not include a diazole. Other useful dehydrating agents can include diacetyl oxide, butyryl oxide, benzoyl oxide, 1,3-dichlorohexyl carbodiimide, N, N-dicyclohexyl carbodiimide, benzenesulfonyl chloride, thionyl chloride and phosphorus pentachloride. In some embodiments, the dehydrating agent can also act as a catalyst to enhance the reaction kinetics for the imidization. The anhydride dehydrating material is typically used in a slight molar excess of the amount of amide acid groups present in the polyamic acid solution. In one embodiment, the amount of dehydrating agent used is typically about 2.0 to 4.0 moles per equivalent of the polyamic acid formula unit. Generally, a comparable amount of tertiary amine catalyst is used. The ratio of these catalysts and their concentration in the polyamic acid solution will influence imidization kinetics and the film properties. Polyimide film layers having substantially chemically converted polyimide can have imidization catalysts present in the polyimide film layer in an amount in the range of from 1 part per billion (ppb) to 1 wt %, from 10 ppb to 0.1 wt %, or from 100 ppb to 0.01 wt %.

### Multilayer Films

In one embodiment, a multilayer film can be formed by first forming a release film having a polymer substrate coated with a release layer. In one embodiment, a polymer substrate having a glass transition temperature (Tg) in the range of approximately 370-400° C. and having 60° gloss value in a range of from 10 to greater than 120 gloss units can be coated in a roll-to-roll process with a coating solution containing a silane, and dried, forming a release layer with a thickness of less than 0.5 μm. Such a release layer can increase the water contact angle of the polymer substrate. The release film can then be coated with a polyamic acid coating solution, dried and cured to temperatures of up to 400° C. to form a multilayer film with a polyimide film layer having no visual imperfections such as blisters, etc. The polyimide film layer can be delaminated from the supporting substrate to give a free-standing film having a thickness of 10 μm or less and free of visual defects such as wrinkles, tears, or curl.

In one embodiment a difference between a Tg of a polymer substrate and a Tg of a polyimide film is 35 degrees or less, 30 degrees or less, 25 degrees or less, 20 degrees or less, or 15 degrees or less.

In one embodiment, an adhesive layer may be deposited onto a multilayer film in contact with the polyimide film layer on a side opposite the release layer, with the purpose of the adhesive layer being to hold the polyimide film in place, once released from the substrate and applied to another surface. In one embodiment, the adhesive consists of an epoxy resin and hardener, and, optionally, further contains additional components, such as, an elastomer, curing accelerator (catalyst), hardener, filler and flame retardant.

In one embodiment, the adhesive is an epoxy resin. In some embodiments, the epoxy resin is selected from the group consisting of Bisphenol F type epoxy resin, Bisphenol S type epoxy resin, Phenol novolac type epoxy resin, Biphenyl type epoxy resin, Biphenyl aralkyl type epoxy resin, Aralkyl type epoxy resin, Dicyclopentadiene type epoxy resin, Multifunctional type epoxy resin, Naphthalene type epoxy resin, Rubber modified epoxy resin, and mixtures thereof.

In another embodiment, the adhesive is an epoxy resin selected from the group consisting of bisphenol A type epoxy resin, cresol novolac type epoxy resin, phosphorus containing epoxy resin, and mixtures thereof. In some embodiments, the adhesive is a mixture of two or more epoxy resins. In some embodiments, the adhesive is a mixture of the same epoxy resin having different molecular weights.

In one embodiment, the epoxy adhesive contains a hardener. In one embodiment, the hardener is a phenolic compound. In some embodiments, the phenolic compound is selected from the group consisting of Novolac type phenol resin, Aralkyl type phenol resin, Biphenyl aralkyl type phenol resin, Multifunctional type phenol resin, Nitrogen containing phenol resin, Dicyclopentadiene type phenol resin, Phosphorus containing phenol resin, and Triazine containing phenol novolac resin.

In another embodiment, the hardener is an aromatic diamine compound. In some embodiments, the aromatic diamine compound is a diaminobiphenyl compound. In some embodiments, the diaminobiphenyl compound is 4,4′-diaminobiphenyl or 4,4′-diamino-2,2′-dimethylbiphenyl. In some embodiments, the aromatic diamine compound is a diaminodiphenylalkane compound. In some embodiments, the diaminodiphenylalkane compound is 4,4′-diaminodiphenylmethane or 4,4′-diaminodiphenylethane. In some embodiments, the aromatic diamine compound is a diaminodiphenyl ether compound. In some embodiments, the diaminodiphenyl ether compounds is 4,4′-diaminodiphenylether or di(4-amino-3-ethylphenyl) ether. In some embodiments, the aromatic diamine compound is a diaminodiphenyl thioether compound. In some embodiments, the diaminodiphenyl thioether compound is 4,4′-diaminodiphenyl thioether or di(4-amino-3-propylphenyl)thioether. In some embodiments, the aromatic diamine compound is a diaminodiphenyl sulfone compound. In some embodiments, the diaminodiphenyl sulfone compound is 4,4′-diaminodiphenyl sulfone or di(4-amino-3-isopropylphenyl) sulfone. In some embodiments, the aromatic diamine compound is phenylenediamine. In one embodiment, the hardener is an amine compound. In some embodiments, the amine compound is a guanidine. In some embodiments, the guanidine is dicyandiamide (DICY). In another embodiment, the amine compound is an aliphatic diamine. In some embodiments, the aliphatic diamine is ethylenediamine or diethylenediamine.

In one embodiment, the epoxy adhesive contains a catalyst. In some embodiments, the catalyst is selected from the group consisting of imidazole type, triazine type, 2-ethyl-4-methyl-imidazole, triazine containing phenol novolac type and mixtures thereof.

In one embodiment, the epoxy adhesive contains an elastomer toughening agent. In some embodiments, the elastic toughening agent is selected from the group consisting of ethylene-acryl rubber, acrylonitrile-butadiene rubber, carboxy terminated acrylonitrile-butadiene rubber and mixtures thereof.

In one embodiment, the epoxy adhesive contains a flame retardant. In some embodiments, the flame retardant is selected from the group consisting of aluminum trihydroxide, melamine polyphosphate, condensed polyphosphate ester, other phosphorus containing flame retardants and mixtures thereof.

In one embodiments, the adhesive layer is selected from the group consisting of polyimide, butyral phenolic, polysiloxane, polyimidesiloxane, fluorinated ethylene propylene copolymers, perfluoroalkoxy copolymers, ethylene vinyl acetate copolymers, ethylene vinyl acetate glycidyl acrylate terpolymer, ethylene vinyl acetate glycidyl methacrylate terpolymer, ethylene alkyl acrylate copolymers with adhesion promoter, ethylene alkyl methacrylate copolymers with adhesion promoter, ethylene glycidyl acrylate, ethylene glycidyl methacrylate, ethylene alkyl acrylate glycidyl acrylate terpolymer, ethylene alkyl methacrylate glycidyl acrylate terpolymer, ethylene alkyl acrylate maleic anhydride terpolymers, ethylene alkyl methacrylate maleic anhydride terpolymers, ethylene alkyl acrylate glycidyl methacrylate terpolymers, ethylene alkyl methacrylate glycidyl methacrylate terpolymers, alkyl acrylate acrylonitrile acrylic acid terpolymers, alkyl acrylate acrylonitrile methacrylic acid terpolymers, ethylene acrylic acid copolymer including salts thereof, ethylene methacrylic acid copolymer including salts thereof, alkyl acrylate acrylonitrile glycidyl methacrylate terpolymers, alkyl methacrylate acrylonitrile glycidyl methacrylate terpolymers, alkyl acrylate acrylonitrile glycidyl acrylate terpolymers, alkyl methacrylate acrylonitrile glycidyl acrylate terpolymers, polyvinyl butyral, ethylene alkyl acrylate methacrylic acid terpolymers and salts thereof, ethylene alkyl methacrylate methacrylic acid terpolymers and salts thereof, ethylene alkyl acrylate acrylic acid terpolymers and salts thereof, ethylene alkyl methacrylate acrylic acid terpolymers and salts thereof, ethylene ethyl hydrogen maleate, ethylene alkyl acrylate ethyl hydrogen maleate, ethylene alkyl methacrylate ethyl hydrogen maleate, and mixtures thereof.

In one embodiment, the multilayer film additionally includes an outer layer of release paper in contact with an adhesive layer on a side opposite the polyimide film layer. The release paper can be removed before adhering the polyimide film to a component in an electronic device, such as a printed circuit board.

In one embodiment, a multilayer film can be used to form a film comprising a black polyimide film and an adhesive layer and is useful as a coverlay package.

### Applications

In one embodiment, a multilayer film can be used to form a polyimide film that can be used in electronic device applications, such as a coverlay for a printed circuit board or other electronic components in an electronic device, providing protection from physical damage, oxidation and other contaminants that may adversely affect the function of the electronic components. Very thin coverlays of polyimide films can resist etching during the pumice, desmear, and plasma processes used in circuit production.

A polyimide film for a thin coverlay can be provided in the form of a coverlay package having a multilayer film.

The advantageous properties of this invention can be observed by reference to the following examples that illustrate, but do not limit, the invention. All parts and percentages are by weight unless otherwise indicated.

### EXAMPLES

### Test Methods

### Glass Transition Temperature

Glass transition temperature (Tg) was measured using a Q800 (TA Instruments). A sample of approximate dimensions ¼″×0.393″ was heated from 22 to 400° C. (or alternatively from 35 to 500° C.) at a rate of 5° C./min in dry air and a clamp distance in the range of 7-10 mm, and the value of the tan delta peak was reported.

### Thickness

Thickness of free-standing film samples was determined using a Heidenhein CT2501 with motorized actuator and a 1 mm diameter flat probe tip. The average value of at least 5 independent measurements is reported.

### Mechanical Properties

Elongation to break/Youngs Modulus/Tensile strength: Sample strips of dimensions 0.5″ width were prepared by placing the film sample between two sheets of Kraft paper and using a Thwing-Albert JDC Precision Sample Cutter. Strips were then cut to 1″ length.

Samples were evaluated using a tensile tester with 1 kN load cell, a cross head space of 1″, and a crosshead speed of 2″/min. The average value for elongation to break, modulus, and tensile strength from at least 5 independent measurements was reported for both MD (machine direction) and TD (transverse direction).

### Gloss

A BYK Gardner Micro-Tri-Gloss Meter with integrated High Gloss standard was used. Gloss was determined at 60°.

### Coefficient of Thermal Expansion

Coefficient of thermal expansion (CTE) was measured using a Q400 (TA Instruments), a sample size of ˜8 mm×⅛″, a heating rate of 10° C./min and a preload force of 0.05 N. The average dimensional change for MD (machine direction) and TD (transverse direction) in the range of 50-250° C. was reported.

### Color

A HunterLab ColorQuest XE Spectrophotometer was used with a setting of D65/10 for Illuminant/Observer. L*, a* and b* values were reported on the CIELAB scale.

### Optical Density

A Macbeth TD904 Densitometer was used. The average value of at least 5 independent measurements was reported.

### Residual Volatiles

Residual amounts of volatiles were determined using a Discovery TGA 550 and by heating a sample specimen from 22° C. to 160° C. (ramp rate 10° C./min), holding for 30 min, heating to 250° C. (ramp rate 10° C./min), holding for 90 min, heating to 340° C. (ramp rate 10° C./min), then folding for 60 min. The total amount of observed weight loss after reaching 160° C. was then reported.

### Thermal Stability

A Pyrolysis GC/MS setup was used. The sample was heated at 400° C. for one minute and any volatiles that evolved from the sample were trapped downstream of the sample at the temperature of liquid nitrogen. The trapped compounds were then volatilized again and separated and detected by GC/MS.

### Viscosity

Determined at 25° C. using a B5 DV3TRVTJO Viscometer and spindle type 31.

### Contact Angle

Water-contact angles were determined using a Biolin Scientific Attention Theta Flex Optical Tensiometer. Deionized water was dispensed using a 1 milliliter adjustable precision syringe with a 22-gauge needle.

### Silicon Content

Silicon content was determined using surface analysis via X-ray Photoelectron Spectroscopy (XPS). XPS analysis was performed at a 45° exit angle (at ˜7 nm) with an Al K_{α} anode monochromatic X-ray source using a PHI Quantera instrument. Area analyzed was 200×200 μm². Depth profiles were performed using GCIB Ar⁺ with raster size at 3×3 mm².

### Surface Roughness

Surface roughness was measured using a ZeGage™ Pro 3D optical profiler (Zygo Corp., Middlefield, CT) over a 167×167 μm area (0.28 mm²). The maximum roughness (Sₚᵥ) is the sum of the maximum peak height (Sₚ) and the maximum valley depth (Sᵥ) of the surface being measured. Sₚ is defined as the value of the highest data point in the areal sample. Sᵥ is defined as the value of the lowest data point in the areal sample.

### Release

The cured film was released from the substrate by either partially applying a thin strip of pressure-sensitive adhesive tape onto the surface of the cured film at an edge of the cured film and slowly lifting the tape up at an angle of approximately 90 degrees relative to the substrate, or by carefully pulling on the cured film at an edge of the cured film with a very fine spatula or tweezers.

### Preparation of Polyamic Acid Coating Solutions

Solutions of polyamic acid in DMAc solvent were prepared using the monomers shown in Table 1. Generally, the diamine monomers were first dissolved in DMAc and agitated at 20-25° C. with a mechanical stirrer under an atmosphere of nitrogen. Dianhydride monomers were added as solids over a short period of time until a viscosity of 50-100 Poise (for polymers A and B) or 5-10 Poise (for polymer C) was reached. At this point, a slurry of 10 wt % carbon black in DMAc was added slowly to the solution until 10 wt % of carbon black (relative to total solid content of the solution) had been added. The resulting dispersion was agitated for 30 minutes, and then treated with portions of a 6 wt % solution of pyromellitic dianhydride (PMDA) in DMAc until final viscosities as shown below were obtained. The final coating formulation was filtered using either a nominal 30 μm or 10 μm filter.

TABLE 1

| | | Final | Total |
|---|---|---|---|
| | Composition | Viscosity | Solids |
| Composition | (wt %) | (Poise) | (wt %) |
| A | PMDA (56)//ODA (32)/PPD (12) | 1750 | 17 |
| B | BPDA (65)/PMDA (7)//ODA (3)/ | 191 | 14 |
| | PPD (26) | | |
| C | BPDA (30)/PMDA (32)//ODA (21)/ | 1380 | 15 |
| | PPD (17) | | |

### Examples 1 to 7

For Examples 1 to 7 (E1-E7), release films were made having a polymer substrate coated with a release layer. Kapton® polyimide films based on a H-type polyimide composition (DuPont) having a Tg in the range of approximately 370-400° C. and having 60° gloss values in a range of 10 to greater than 120 gloss units were used as polymer substrates and were coated in a roll-to-roll process with a coating solution containing silanol-terminated poly(dimethyl-substituted orthosilicic acid) polymers and tris-(N-methylamine)methylsilane, and/or reaction products thereof in n-dibutyl ether, and dried (by successively exposing the coating to temperatures ranging from 38 to 107° C.). The resulting coating weight (by measuring representative pieces of substrate before and after applying and curing the release coating and using an average value; ASTM F2217 was modified for this purpose) showed that approximately 20 to 200 mg of solids per square meter had been deposited on the substrate, which translates to an approximate coating thickness of less than 0.5 μm. A thermal stability test conducted at 400° C. only detected non-silicone containing volatiles at a concentration of less than 250 ppm from the produced coating. The water-contact angle of the coated polyimide film surface changed from 60-85° (for the uncoated film) to 95-110° after applying the release layer, as shown in Table 2.

TABLE 2

| | | | | Water-Contact Angle (°) | | | |
|---|---|---|---|---|---|---|---|
| | | | | | Side treated with | | Surface |
| | Substrate | Substrate | Substrate | Untreated | release coating/ | Substrate Si | Roughness |
| | Thickness | 60° Gloss | T_{g} | sides (front/ | remaining | Content | Peak Height |
| Example | (μm) | (GU) | (° C.) | back) | untreated side | (atom %) | (Sₚ) |
| E1 | 50.8 | >120 | 398 | 75/81 | 102/84 | 16.4 | — |
| E2 | 25.4 | 20-25 | 387 | 62/69 | 106/69 | 17.8 | — |
| E3 | 12.7 | 20-25 | 376 | 69/73 | 105/66 | 17.8 | — |
| E4 | 25.4 | 20-25 | 387 | 62/69 | 108/74 | 18.3 | 3.04 |
| E5 | 25.4 | 20-25 | 387 | 62/69 | 104/75 | 8.3 | 2.81 |
| E6 | 25.4 | 20-25 | 387 | 62/69 | 105/75 | 3.2 | — |
| E7 | 50.8 | >120 | 398 | 75/81 | N/A | — | — |
| E8 | 25.4 | 20-25 | 387 | 62/69 | N/A | — | — |

The release films were then coated with polyamic acid coating solutions. The previously prepared solutions of polyamic acid were coated in a roll-to-roll process onto the release films by adjusting the solution viscosity through dilution with DMAc, and dried (by successively exposing the coating to temperatures ranging from 85 to 130° C.) to a solid content in the coating of ˜73%. Sheet samples were cut from the resulting roll, mounted on pin frames, and then cured in a convection oven by heating the film from 120 to 320° C. at a ramp rate of approximately 13° C./min, and then heating at 400° C. for 5 minutes, followed by cooling to 22° C.

The resulting polyimide film showed no visual imperfections such as blisters etc. and was released from the pin frame, and then delaminated from the supporting substrate to give a free-standing film of approximately 5 μm thickness. No premature release of the coating from the supporting substrate was observed. The released polyimide film was free of visual defects such as wrinkles, tears, or curl.

### Comparative Examples 1 and 2

For Comparative Examples 1 and 2 (CE1 and CE2), polyamic acid coating solutions were coated directly onto polymer substrates that did not have a release layer, following the procedure above for E1-E7.

Comparative Examples 1 and 2 showed that in the absence of a release layer, it was impossible to separate the resulting polyimide film layer from the substrate.

### Comparative Examples 3 and 4

For Comparative Examples 3 and 4 (CE3 and CE4), a carbon black slurry was prepared, consisting of 80 wt % DMAc, 10 wt % polyamic acid prepolymer solution (20.6 wt % polyamic acid solids in DMAc), and 10 wt % low conductivity carbon black powder (Special Black 4, from Evonik Degussa). The ingredients were thoroughly mixed in a rotor stator, high-speed dispersion mill. The slurry was then processed in a ball mill to disperse any large agglomerates and to achieve the desired particle size. The median particle size of the slurry was 0.3 μm.

23 kg of the carbon black slurry was mixed into 158 kg of a prepolymer solution of polymer composition C (20.6% polyamic acid solids, approximately 50 Poise viscosity) in a 50-gallon (189.3 liters) tank. The tank was equipped with three independently controlled agitator shafts: a low-speed anchor mixer, a high-speed disk disperser, and a high-shear rotor-stator emulsifier. The mixture was “finished” by adding and mixing, in increments, approximately 7 kg of a 5.8 wt % PMDA solution in DMAc, in order to increase molecular weight and raise the viscosity to approximately 3000 Poise. The speeds of the anchor, disperser, and emulsifier were adjusted as necessary to ensure efficient mixing and dispersion, without excessively heating the mixture. The temperature of the mixture was further regulated by flowing chilled ethylene glycol through the mixing tank jacket. The finished solution was filtered through a 20 μm filter and vacuum degassed to remove entrained air.

The mixture was cooled to approximately 6° C., conversion chemicals acetic anhydride (0.14 cm³/cm³ polymer solution) and beta-picoline (0.15 cm³/cm³ polymer solution) were metered in and mixed, and a film was cast using a slot die, onto a 90° C. hot, rotating drum. The resulting gel film was stripped off the drum and fed into a tenter oven, where it was dried and cured to a solids level greater than 98%, using convective and radiant heating. The film contained 7 wt % carbon black.

A strong anisotropy was noticed in CE3 and CE4 as evident from the different CTE values in MD and TD direction.

### Comparative Example 5

For Comparative Example 5 (CE5), polyamic acid coating solution was coated directly onto a polymer substrate following the procedure above for E1-E7. The substrate had an insufficient release layer as shown in Table 2 Si content and the films inability to release from the substrate.

The free-standing films were characterized, and properties are summarized in Tables 3 and 4. E1-E3 showed that the various polymer compositions A, B, and C could be successfully applied, cured, and released from substrates that differed in thickness as well as initial 60° gloss value. Additionally, a reliable transfer of gloss value was observed in E4-E7. Moreover, E4-E7 showed a difference in gloss value between the two sides of a given polyimide film, demonstrating that the gloss values and valley depths are higher on the side of the polyimide film that faced away from the substrate.

Referring to Table 4, E1-E7 all displayed almost no difference in the thermal coefficient of expansion (CTE) in machine (MD) and traverse direction (TD), indicating that these films were almost isotropic in this regard.

TABLE 3

| | | | | Film | | Film 60° Gloss | | | | |
|---|---|---|---|---|---|---|---|---|---|---|
| | | Polymer | Film | Thick | T_{g} | (GU) | | Film Color | | |
| Example | Substrate | Comp | Release | (μm) | (° C.) | air | substrate | L* | a* | b* |
| E1 | 1 | C | Yes | 4.7 | 373 | 94 | 118 | 33 | −0.02 | −2.50 |
| E2 | 1 | A | Yes | 4.7 | 404 | 99 | 106 | 33 | 0.20 | −1.84 |
| E3 | 1 | B | Yes | 4.7 | 342 | 95 | 114 | 36 | 0.08 | −3.20 |
| E4 | 2 | A | Yes | 4.6 | 403 | 53 | 24 | 32 | −0.09 | −2.08 |
| E5 | 3 | A | Yes | 4.8 | 407 | 54 | 23 | 32 | −0.09 | −2.13 |
| E6 | 4 | A | Yes | 5 | 420 | 70 | 24 | 31 | −0.10 | −2.09 |
| E7 | 5 | A | Yes | 5 | 417 | 70 | 24 | 32 | −0.12 | −2.09 |
| CE1 | 7 | A | No | 4.7 | — | — | — | — | — | — |
| CE2 | 8 | A | No | 4.7 | — | — | — | — | — | — |
| CE3 | None | C | — | 5.3 | — | 109 | 109 | 35 | −0.15 | −2.51 |
| CE4 | None | C | — | 5.1 | — | — | — | — | — | — |
| CE5 | 6 | A | No | — | — | — | — | — | — | — |

TABLE 4

| | Tensile Strength | | | Elongation | | | Modulus | | | CTE | | |
|---|---|---|---|---|---|---|---|---|---|---|---|---|
| | (kpsi) | | | (%) | | | (kpsi) | | | (ppm/° C.) | | |
| Example | MD | TD | Avg | MD | TD | avg | MD | TD | avg | MD | TD | avg |
| E1 | 22 | 21 | 22 | 10 | 10 | 10 | 497 | 546 | 522 | 23 | 21 | 22 |
| E2 | 18 | 18 | 18 | 22 | 23 | 23 | 343 | 352 | 347 | 28 | 27 | 27 |
| E3 | 26 | 28 | 27 | 5 | 6 | 5 | 864 | 870 | 867 | 19 | 18 | 18 |
| E4 | 22 | 23 | 23 | 49 | 43 | 46 | 348 | 386 | 367 | 26 | 28 | 27 |
| E5 | 22 | 22 | 22 | 39 | 40 | 40 | 334 | 319 | 327 | 27 | 27 | 27 |
| E6 | 21 | 19 | 20 | 49 | 36 | 43 | 387 | 424 | 406 | 35 | 35 | 35 |
| E7 | 21 | 22 | 22 | 51 | 55 | 53 | 374 | 336 | 355 | 37 | 38 | 38 |
| CE1 | — | — | — | — | — | — | — | — | — | — | — | — |
| CE2 | — | — | — | — | — | — | — | — | — | — | — | — |
| CE3 | 37 | 34 | 36 | 43 | 39 | 41 | 619 | 603 | 611 | 4 | 21 | 13 |
| CE4 | 38 | 38 | 38 | 36 | 27 | 32 | 605 | 559 | 582 | 9 | 19 | 14 |

For E6 and E7, the Si content on the surface and the surface roughness were further characterized and are shown in Table 5. E6 and E7 showed that various release quantities (as shown via Si content) can be used on the substrate to make film that both releases from the substrate and maintains desired gloss. Furthermore, surface roughness imaging of the films and substrates showed that the substrate transfers gloss by imparting valley depths to film that are the inverse of the peak heights seen in the substrate. Polyimide films derived from multilayer film structures can have a Si content of less than 1 atom % on their surfaces.

TABLE 5

| | Film Si | | Film Surface Roughness (μm) | | | | | |
|---|---|---|---|---|---|---|---|---|
| | (atom %) | | Sₚᵥ | | Sₚ | | Sᵥ | |
| Example | air | substrate | air | substrate | air | substrate | air | substrate |
| E6 | 0.2 | 0.4 | 2.17 | 4.40 | 1.42 | 1.37 | −0.75 | −3.03 |
| E7 | 0.2 | 0.2 | 1.91 | 4.40 | 1.32 | 1.21 | −0.59 | −3.19 |

What is claimed is:

1. A multilayer film comprising:
a polymer substrate having a glass transition temperature of 240° C. or higher;
a release layer adhered to the polymer substrate, wherein the release layer comprises a cross-linked silicone having a decomposition temperature of 350° C. or higher; and
a polyimide film layer releasably adhered to the release layer on a side opposite the polymer substrate, wherein the polyimide film layer has a thickness of 10 μm or less.

2. The multilayer film of claim 1, wherein a difference between the glass transition temperature of the polymer substrate and a glass transition temperature of the polyimide film is 35 degrees or less.

3. The multilayer film of claim 1, wherein a difference between coefficients of thermal expansion of the polyimide film layer in a machine direction and a transverse direction is 5 ppm/° C. or less.

4. The multilayer film of claim 1, wherein the release layer has a water-contact angle in a range of from 95° to 115°.

5. The multilayer film of claim 1, wherein the release layer has a thickness in a range of from 5 to 500 nm.

6. The multilayer film of claim 1, wherein the polymer substrate has a thickness in a range of from 7 to 100 μm.

7. The multilayer film of claim 1, wherein the polyimide film layer further comprises a colorant.

8. The multilayer film of claim 7, wherein the colorant comprises carbon black.

8. The multilayer film of claim 1, wherein the polyimide film layer has an optical density of 1.5 or more, when measured on a film having a thickness of 5 μm.

9. The multilayer film of claim 1, wherein the polyimide film layer further comprises a matting agent.

10. The multilayer film of claim 1, wherein the polyimide film layer has an L* of 40 or less.

11. The multilayer film of claim 1, wherein on a side in contact with the release layer, the polyimide film layer has a 60° gloss of 30 or less.

12. The multilayer film of claim 11, wherein on a side not in contact with the release layer, the polyimide film layer has a 60° gloss that is greater than the 60° gloss of the side in contact with the release layer by at least 20 gloss units.

13. The multilayer film of claim 1, wherein on a side in contact with the release layer, the polyimide film layer has a surface roughness peak (Sₚ) value of less than 3 μm.

14. The multilayer film of claim 1, wherein the polyimide film layer comprises a polyimide derived from a dianhydride and a diamine, wherein the dianhydride comprises pyromellitic dianhydride and the diamine comprises 4,4′-diaminodiphenylether and p-phenylenediamine.

15. The multilayer film of claim 1, wherein the polyimide film layer has a Si content of less than 1 atom % on both surfaces.

16. A polyimide film having a thickness of 10 μm or less derived from the multilayer film of claim 1, wherein the polyimide film has been removed from the polymer substrate and release layer.

17. A coverlay package comprising the multilayer film of claim 1, an adhesive layer adhered to the polyimide film layer on a side opposite the release layer, and a release film releasably adhered to the adhesive layer on a side opposite the polyimide film layer.
